(19) United States
(12) Patent Application Publication
(10) Pub. No.: US 2021/0277181 A1
(43) Pub. Date: Sep. 9, 2021

(54) PROCESS FOR SEPARATING GASEOUS CONSTITUENTS

(71) Applicant: Covestro Intellectual Property GmbH & Co. KG, Leverkusen (DE)

(72) Inventors: Matthias Wohak, Dormagen (DE); Joerg Hofmann, Krefeld (DE); Stefanie Braun, Köln (DE); Maria Francisco Casal, Leverkusen (DE); Werner Bäcker, Wipperfürth (DE); Thomas Runowski, Hilden (DE)

(21) Appl. No.: 17/270,748

(22) PCT Filed: Aug. 13, 2019
(86) PCT No.: PCT/EP2019/071729

§ 371 Date: Feb. 23, 2021

(30) Foreign Application Priority Data
Aug. 30, 2018 (EP) 18191602.4

(51) Int. Cl. C08G 64/40; C08G 65/26; C08G 64/34; C08G 64/20

(52) U.S. Cl. CPC C08G 64/406; C08G 65/2663; C08G 64/205; C08G 64/34; C08G 65/2603

(57) ABSTRACT

The present invention provides a process for removing gaseous constituents dissolved in liquid reaction mixtures in the copolymerization of alkylene oxide and carbon dioxide, characterized in that
(η) prior to decompression the liquid reaction mixture has a pressure of 5.0 to 100.0 bar (absolute), wherein the following process stages are performed in the specified sequence:
   (i) decompression of the reaction mixture by at least 50% of the prevailing pressure,
   (ii) subsequent droplet separation with first defoaming and
   (iii) subsequent bubble separation with second defoaming to clarify the liquid phase, wherein the process stages (i) to (iii) are performed one or more times until the resulting reaction mixture has a pressure of 0.01 to <5.00 bar (absolute),
and also a process for preparing polyethercarbonate polyols comprising the process stages (i)-(iii).

### CROSS REFERENCE TO RELATED APPLICATIONS

This application is a U.S. national stage application, filed under 35 U.S.C. § 371, of International Application No. PCT/EP2019/071729, which was filed on Aug. 13, 2019, and which claims priority to European Patent Application No. 18191602.4, which was filed on Aug. 30, 2018. The contents of each are incorporated by reference into this specification.

### FIELD

The present invention relates to a process for removing gaseous constituents dissolved in liquid reaction mixtures in the copolymerization of alkylene oxide and carbon dioxide.

### BACKGROUND

The preparation of polyethercarbonate polyols by catalytic reaction of alkylene oxides (epoxides) and carbon dioxide in the presence of H-functional starter substances (“starters”) has been the subject of intensive study for more than 40 years (e.g. Inoue et al., Copolymerization of Carbon Dioxide and Epoxide with Organometallic Compounds; Die Makromolekulare Chemie 130, 210-220, 1969). This reaction is shown in schematic form in scheme (I), where R is an organic radical such as alkyl, alkylaryl or aryl, each of which may also contain heteroatoms, for example O, S, Si, etc., and where e, f and g are each integers, and where the product shown here in scheme (I) for the polyethercarbonate polyol should merely be understood in such a way that blocks having the structure shown may in principle be present in the polyethercarbonate polyol obtained, but the sequence, number and length of the blocks and the OH functionality of the starter may vary and is not restricted to the polyethercarbonate polyol shown in scheme (I). This reaction (see scheme (I)) is highly advantageous from an environmental standpoint since this reaction is the conversion of a greenhouse gas such as CO₂ to a polymer. A further product formed, actually a by-product, is the cyclic carbonate shown in scheme (I) (for example, when R=CH₃, propylene carbonate).

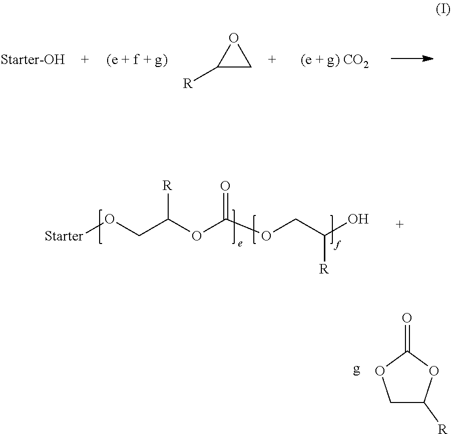

The process for preparing polyethercarbonate polyols is generally carried out at a stoichiometric excess of CO₂ and a resulting reaction pressure. This results in the technical necessity of removing this excess CO₂ (possibly together with unreacted alkylene oxide) at the end of the reaction.

U.S. Pat. No. 4,500,704 discloses a process for preparing linear copolymers/polycarbonates from carbon dioxide and alkylene oxide using a zinc-iron-based double metal cyanide complex catalyst, wherein the decomposition of the reaction pressure of 100-1500 psi (6.9-103.4 bar) preferably brought about by the CO₂ addition is undertaken batchwise via a slow decompression in the reaction vessel.

EP-A 0 222 453 discloses a process for preparing polycarbonates from alkylene oxides and carbon dioxide using a catalyst system composed of DMC catalyst and a cocatalyst (such as zinc sulfate) at pressures of 2-40 bar. Examples 1-7 disclose a cooling of the reactor contents and subsequent withdrawal, wherein care is to be taken to ensure separation of the carbon dioxide without “frothing problems”. Disclosed as an alternative is stripping in the reactor for simultaneous removal of unreacted epoxides.

WO-A 2008/024363 discloses a process for preparing non-strictly alternating copolymers (molar mass of 500-500 000 g/mol) based on propylene oxide and CO₂ in the presence of a double metal cyanide complex containing proportions of tetracyanometalate at pressures of up to 1500 psig (103.4 bar) and temperatures of 10° C.-150° C. The reaction pressure is reduced batchwise by cooling the reactor and decompression before removal of the reaction product.

WO-A 2008/092767 discloses inter alia a continuous process mode in the preparation of polycarbonate polyols using DMC catalysts at pressures up to 30 bar in the temperature range of 60-150° C., wherein the removal of the CO₂ and of residual alkylene oxide is carried out by application of a vacuum followed by a further workup to remove volatile secondary components and optionally the catalyst. The examples show that the reactor contents are decompressed and further volatile constituents are subsequently stripped from the product under vacuum.

The prior art (DE10147711, U.S. Pat. No. 6762278, DE10147712, WO-A 2006103213, WO-A 2006103214) discloses a process using double metal cyanide catalysts for preparing polyols from oxirane compounds and for example CO₂ at pressures of up to 20 bar, wherein the reaction pressure is reduced batchwise by cooling the reactor and decompression before removal of the reaction product, and a solvent is optionally employed to take up the produced polymer.

The recited single-stage, batchwise processes with decompression in the reactor are disadvantageous since during the sometimes time-consuming decompression the reactor is not available for the next batch and are therefore only suitable for the laboratory scale.

WO-A 2011/028056 discloses a continuous process for preparing highly polymeric, aliphatic polycarbonates (i.e. a polymer chain consisting of a strict sequence of linear carbonate units and substantially free from polyether sequences) from one or more alkylene oxides and CO₂ in the presence of an organic metal complex catalyst at pressures in the range of 0-98 bar and temperatures of 20-120° C. which inter alia includes continuous removal of the polymer from the not yet fully reacted monomers (including resolution of the monomer mixture and recycling into the reaction) and removal of a reaction solvent. Following the reaction the reaction mixture is initially supplied to a catalyst removal, wherein in some cases considerable amounts of additional alkylene oxide (see Ex. 1 and 2) or of a solvent are added. The mixture is subsequently supplied to a plurality of phase separators in which the predominant proportion of the unreacted alkylene oxides, optionally solvent and CO₂ (>93%) are evaporated and the polymer is retained. The first phase separation is carried out at pressures in the range of 0-10 kg/(cm²g) (0-9.8 bar) and temperatures in the range of 40-200° C. in a separator which removes about 30-80% of the alkylene oxide and CO₂; the downstream second stage of the phase separation is operated at 0-5 kg/(cm²g) (0-4.9 bar) and 40-200° C. and removes at least >90% of the remaining constituents of unreacted alkylene oxide and CO₂.

This document accordingly describes a process concerned with decompression of reaction mixtures to which considerable amounts of alkylene oxide and optionally solvent are added for removal of the catalyst (Ex. 1: 650% PO based on polymer, Ex. 2: 550% PO based on polymer). However, a person skilled in the art gains no indication of the specific implementation and configuration of the two abovementioned separation stages.

### SUMMARY

The problem addressed by the present invention is accordingly that of providing an efficient and cost-effective process for removing CO₂ and any further residual alkylene oxides present. It is especially an objective to provide a continuous process for decompression and subsequent removal of the gas phase, in particular CO₂, formed during the decompression using the simplest and most robust possible apparatuses in order thus to minimize the apparatus and energy costs for the decompression apparatus and the offgas system.

It has surprisingly been found that the technical problem is solved by a process for removing gaseous constituents dissolved in liquid reaction mixtures in the copolymerization of alkylene oxide and carbon dioxide, characterized in that
(η) prior to decompression the liquid reaction mixture has a pressure of 5.0 to 100.0 bar (absolute), wherein the following process stages are performed in the specified sequence:
   (i) decompression of the reaction mixture by at least 50% of the prevailing pressure,
   (ii) subsequent droplet separation with first defoaming and
   (iii) subsequent bubble separation with second defoaming to clarify the liquid phase, wherein the process stages (i) to (iii) are performed one or more times until the resulting reaction mixture has a pressure of 0.01 to <5.00 bar (absolute).

This process is particularly suitable for use in the preparation of polyethercarbonate polyols. The invention thus further provides a process for preparing polyethercarbonate polyols by addition of alkylene oxide and carbon dioxide onto H-functional starter substance in the presence of a double metal cyanide (DMC) catalyst or a metal complex catalyst based on the metals zinc and/or cobalt, wherein
(γ) alkylene oxide and carbon dioxide are added onto H-functional starter substance in a reactor in the presence of a double metal cyanide catalyst or in the presence of a metal complex catalyst based on the metals zinc and/or cobalt to obtain a reaction mixture containing the polyethercarbonate polyol,
(δ) the reaction mixture obtained in step (γ) optionally remains in the reactor or is optionally continuously transferred into a postreactor, wherein in each case by way of a postreaction the content of free alkylene oxide in the reaction mixture is reduced, and
(η) subsequently CO₂ and any dissolved residual alkylene oxide are removed, wherein prior to decompression the liquid reaction mixture has a pressure of 5.0 to 100.0 bar (absolute), in an operation comprising the process stages
   (i) decompression of the reaction mixture by at least 50% of the prevailing pressure,
   (ii) subsequent droplet separation with first defoaming and
   (iii) subsequent bubble separation with second defoaming to clarify the liquid phase,
   wherein the process stages (i) to (iii) are performed one or more times until the resulting reaction mixture has a pressure of 0.01 to <5.00 bar (absolute).

### DETAILED DESCRIPTION

In the context of the present invention a foam is hereinbelow to be understood as meaning a dispersion of gas and liquid in which the volumetric proportion of gas predominates compared to the liquid. The foam is referred to as a spherical foam at a volumetric gas proportion of 52-74% and as a polyhedral foam above a volumetric gas proportion of 74%. The gas phase is in the form of many separate bubbles while the liquid surrounds these bubbles in the form of an uninterrupted matrix.

Step (η):

Process Stage (i):

In process stage (i) the pressure of the reaction mixture after the actual copolymerization—downstream of the reactor (i.e. the reaction mixture resulting from step (γ)), preferably downstream of the postreactor (i.e. the reaction mixture resulting from step (δ))—is reduced by at least 50%, preferably at least 80%, particularly preferably at least 90% (“decompression”). Employed here are for example throttle plates, throttle valves or other fittings suitable for the defined pressure reduction. This reaction mixture typically has a pressure of 5.0 to 100.0 bar (absolute), preferably 10.0 to 90.0 bar (absolute), particularly preferably 20.0 to 80.0 bar (absolute), prior to decompression. The temperature of the reaction mixture during the decompression may be in the range of 60-150° C., preferably 70-135° C.

Process Stage (ii):

In process stage (ii) the mixture of liquid and gas phase formed during the depressurization is supplied to a droplet separator in order to undertake a first separation of gas and liquid. The result is a very largely droplet-free gas stream consisting primarily of CO₂ and alkylene oxide and a liquid/foam phase.

Droplet separators in the context of the present application are apparatuses which separate a disperse liquid phase in the form of droplets from a biphasic flow comprising a continuous gas phase. The dropletized liquid phase can itself contain gas inclusions in the form of bubbles or even consist largely of gas bubbles that are only separated by liquid lamellae, i.e. the dropletized liquid phase to be separated can itself be a foam according to the above definition. In addition, the liquid phase can also contain dispersed solid particles (for example catalyst particles). The separation is usually carried out with a technical efficiency of less than 100%, i.e. a residue of the disperse phase remains in the original continuous gas phase. Contemplated droplet separators include for example gravity separators, deflection separators, lamella separators, centrifuges, cyclones, knitted wire mesh, sintered materials, membranes, ultrasound, ejectors or nozzles with baffle plates. Preferably employed droplet separators are cyclones or centrifuges.

Particular preference is given to the use of a cyclone as the droplet separator since the typically markedly elevated pressure in the upstream reaction step ensures a sufficient pressure gradient for this apparatus type, which features a low theoretical droplet diameter limit and very low droplet entrainment and has a simple, inexpensive and robust construction (without moving parts and without narrow flow cross-sections). In the context of the present invention “moving parts” is to be understood as meaning that for the separating operation itself no moving parts are employed in the apparatus. The apparatus may thus contain moving parts necessary for maintenance for example. Essential features of the cyclone include a generally vertically arranged cylindrical construction, a tangential entry of the biphasic flow to be separated, an axial exit of the purified gas phase (generally at the upper end of the apparatus) and an axial exit of the separated liquid phase (generally at the lower end of the apparatus). The tangential entry creates a vortex flow in the cyclone whose centrifugal acceleration flings the droplets against the wall where they flow downward as a film or streaks. To improve the flow structure, a cyclone is generally conical in the lower region toward the outlet. Different designs (for example a horizontal or inclined cylinder, an axially traversed apparatus with blades for vortex generation at the entrance) are known to a person skilled in the art from the prior art and are not considered separately in the present observations. Apparatuses for removal of droplets entrained in the gas stream (droplet separators, demisters) may also be installed at the outlet for the gas stream.

In a preferred embodiment the droplet separation in process stage (ii) does not employ an apparatus with moving parts.

The reaction mixture in process stage (ii) may have the same temperature as in process stage (i) or differ therefrom; the reaction mixture in process stage (ii) preferably has a temperature of 60° C. to 150° C., particularly preferably of 70° C. to 135° C.

Process Stage (iii)

Since gas bubbles trapped in the liquid (foam phase) may disrupt subsequent process steps (such as flow measurements for example or through cavitation at pumps) the liquid/foam phase from process stage (ii) is then supplied to a bubble separator in order to obtain a bubble-free product. Bubble separators in the context of the present application are apparatuses which separate a disperse gas phase in the form of bubbles from a biphasic flow comprising a continuous liquid phase; the bubbles themselves may also contain fine droplets of the liquid phase. The biphasic flow may have such a high gas content that the continuous liquid phase is only present in the form of lamellae between the bubbles, i.e. it is a foam according to the above definition. The liquid phase may additionally contain dispersed solids particles.

Contemplated bubble separators include for example measures for mechanical defoaming by means of rotating internals, centrifuges/vacuum centrifuges, demisters, specific knitted fabrics made of different materials and material combinations, ultrasound or else ejectors/nozzles with baffle plates. Simultaneous or sole addition of chemicals for chemical defoaming is likewise possible.

The use of a coalescer as the bubble separator is preferred. Coalescers have the advantage that, compared to a simple residence time vessel (without internals), they may have a markedly smaller volume and are of simple construction. In addition they are virtually wear-free in operation (without moving parts), thus typically also leading to low capital costs, and are simple to operate because the internals are easy to clean or easily replaced.

Essential features of the coalescer are the versatile selection of materials and material combinations and the option of internals (coalescing elements) which may be varied in terms of porosity (via thread thickness and packing density), packing thickness, traversal length and flow rate in the coalescer unit, in each case according to the physical properties of the dispersion. It is preferable to employ in process stage (iii) a coalescer which contains at least one fabric element as a coalescing element. The coalescer preferably contains precisely one fabric element.

Suitable fabric elements in the coalescer include for example knitted fabrics such as for example metal knitted fabrics (for example wire knitted fabrics), combination knitted fabrics made of metal and plastic, pure plastic knitted fabrics, suitable packings of nonwovens of different materials and thread thicknesses or else glass-based knitted fabrics. Preference is given to glass-based knitted fabrics, metal knitted fabrics, combination knitted fabrics made of metal and glass or plastic fibers, particular preference being given to metal knitted fabrics. The fabric elements preferably have a density of 600-1200 kg/m³, particularly preferably 800-1200 kg/m³, particularly preferably 800-1050 kg/m³.

The coalescing elements are installed tightly (to avoid bypass flows) in the traversed cross section of the separator as a homogeneous packing or as packed candles or, for larger apparatuses, also in segment form or as multi-candle elements. Depending on configuration these may be arranged either in horizontally traversed apparatuses or else in vertically traversed apparatuses. The length L of the packing in the direction of flow is defined by the separation task and may be up to a multiple of the apparatus diameter D. The D/L ratio is preferably 0.5 to 5.0, particularly preferably 0.8 to 2.5, especially preferably 0.8 to 1.5 and most preferably 0.9 to 1.1.

The cross section of the packing or candle elements is likewise defined by the separation task and determines the diameter of the coalescer.

The required pressure difference for traversal of the fabric element may preferably be realized via a corresponding hydrostatic height in the feed (for example by arranging an upstream cyclone above the coalescer) or by generating the required pressure difference using a pump. Variations in the fill level in the defoaming chamber are to be minimized through apparatus construction and operating mode.

The temperature of the reaction mixture in process stage (iii) may be identical or different to the temperature in process stage (ii), the reaction mixture in process stage (iii) preferably having a temperature of 60° C. to 150° C., particularly preferably of 70° C. to 135° C. .

The process stages (i) to (iii) are performed one or more times until the resulting reaction mixture has a pressure of 0.01 to <5.00 bar (absolute), preferably 0.01 to 2.5 bar (absolute), particularly preferably 0.01 to 1.2 bar (absolute).

Polyethercarbonate Polyols

The process for removing gaseous constituents dissolved in liquid reaction mixtures in the copolymerization of alkylene oxide and carbon dioxide may especially be employed in the preparation of polyethercarbonate polyols. Polyethercarbonate polyols are prepared by addition of alkylene oxide and carbon dioxide onto an H-functional starter substance in the presence of a DMC catalyst or in the presence of a metal complex catalyst based on the metals zinc and/or cobalt, wherein
(γ) alkylene oxide and carbon dioxide are added onto H-functional starter substance in a reactor in the presence of a double metal cyanide catalyst or in the presence of a metal complex catalyst based on the metals zinc and/or cobalt to obtain a reaction mixture containing the polyethercarbonate polyol,
(δ) the reaction mixture obtained in step (γ) optionally remains in the reactor or is optionally continuously transferred into a postreactor, wherein in each case by way of a postreaction the content of free alkylene oxide in the reaction mixture is reduced, and
(η) subsequently CO₂ and any dissolved residual alkylene oxide are removed, wherein prior to decompression the liquid reaction mixture has a pressure of 5.0 to 100.0 bar (absolute), in an operation comprising the process stages
   (i) decompression of the reaction mixture by at least 50% of the prevailing pressure,
   (ii) subsequent droplet separation with first defoaming and
   (iii) subsequent bubble separation with second defoaming to clarify the liquid phase,
   wherein the process stages (i) to (iii) are performed one or more times until the resulting reaction mixture has a pressure of 0.01 to <5.00 bar (absolute).

In one embodiment, prior to step (γ)
(α) a portion of the H-functional starter substance and/or a suspension medium having no H-functional groups is initially charged in a reactor optionally together with DMC catalyst or a metal complex catalyst based on the metals zinc and/or cobalt,
(β) a DMC catalyst is optionally activated by adding a portion (based on the total amount of alkylene oxide used in the activation and copolymerization) of the alkylene oxide to the mixture resulting from step (a), wherein this addition of a portion of alkylene oxide can optionally be carried out in the presence of CO₂ and wherein the temperature spike (“hotspot”) occurring on account of the subsequent exothermic chemical reaction and/or a pressure drop in the reactor is awaited in each case and wherein step (β) for activation may also be carried out two or more times.

Step (α):

In the process a portion of the H-functional starter substance and/or a suspension medium having no H-functional groups may first be initially charged in the reactor. Subsequently, any amount of catalyst required for the polyaddition is added to the reactor. The sequence of addition is not critical. It is also possible for first the catalyst and then a portion of the H-functional starter substance to be added to the reactor. It is alternatively also possible first to suspend the catalyst in a portion of H-functional starter substance and then to charge the reactor with the suspension.

In a preferred embodiment of the invention, in step (α) the reactor is initially charged with an H-functional starter substance, optionally together with catalyst, without including any suspension medium not containing H-functional groups in the reactor charge.

The catalyst is preferably used in an amount such that the content of catalyst in the resulting reaction product is 10 to 10 000 ppm, more preferably 20 to 5000 ppm, and most preferably 50 to 500 ppm.

In a preferred embodiment, inert gas (for example argon or nitrogen), an inert gas/carbon dioxide mixture or carbon dioxide is introduced into the resulting mixture of (a) a portion of H-functional starter substance and (b) catalyst at a temperature of 90° C. to 150° C., more preferably of 100° C. to 140° C., and at the same time a reduced pressure (absolute) of 10 mbar to 800 mbar, more preferably of 50 mbar to 200 mbar, is applied.

In an alternative preferred embodiment, the resulting mixture of (a) a portion of H-functional starter substance and (b) catalyst is contacted at a temperature of 90° C. to 150° C., more preferably of 100° C. to 140° C., at least once, preferably three times, with 1.5 bar to 10 bar (absolute), more preferably 3 bar to 6 bar (absolute), of an inert gas (for example argon or nitrogen), an inert gas/carbon dioxide mixture or carbon dioxide and then the gauge pressure is in each case reduced to about 1 bar (absolute).

The catalyst can be added in solid form or as a suspension in suspension medium containing no H-functional groups, in H-functional starter substance or in a mixture thereof.

In a further preferred embodiment, in step (α)
(α1) a portion of the H-functional starter substance is initially charged and
(α2) the temperature of the portion of H-functional starter substance is brought to 50° C. to 200° C., preferably 80° C. to 160° C., more preferably 100° C. to 140° C., and/or the pressure in the reactor is lowered to less than 500 mbar, preferably 5 mbar to 100 mbar, wherein an inert gas stream (for example of argon or nitrogen), an inert gas/carbon dioxide stream or a carbon dioxide stream is optionally passed through the reactor,

wherein the catalyst is added to the portion of H-functional starter substance in step (α1) or immediately thereafter in step (α2).

The portion of the H-functional starter substance used in (a) may contain component K, preferably in an amount of at least 100 ppm, more preferably of 100 to 10 000 ppm.

Step (β):

Step (β) serves to activate the DMC catalyst. This step may optionally be performed under an inert gas atmosphere, under an atmosphere composed of an inert gas/carbon dioxide mixture or under a carbon dioxide atmosphere. Activation in the context of this invention refers to a step in which a portion of the alkylene oxide is added to the DMC catalyst suspension at temperatures of 90° C. to 150° C. and then the addition of the alkylene oxide is stopped, with observation of evolution of heat caused by a subsequent exothermic chemical reaction, which can lead to a temperature peak (“hotspot”), and of a pressure drop in the reactor caused by the conversion of alkylene oxide and possibly CO₂. The process step of activation is the period from the addition of the portion of alkylene oxide, optionally in the presence of CO₂, to the DMC catalyst until evolution of heat occurs. Optionally, the portion of the alkylene oxide can be added to the DMC catalyst in a plurality of individual steps, optionally in the presence of CO₂, and then the addition of the alkylene oxide can be stopped in each case. In this case, the process step of activation comprises the period from the addition of the first portion of alkylene oxide, optionally in the presence of CO₂, to the DMC catalyst until the occurrence of the evolution of heat after addition of the last portion of alkylene oxide. In general, the activation step may be preceded by a step for drying the DMC catalyst and optionally the H-functional starter substance at elevated temperature and/or reduced pressure, optionally with passage of an inert gas through the reaction mixture.

The alkylene oxide (and optionally the carbon dioxide) can in principle be metered in in different ways. The metered addition can be commenced from the vacuum or at a previously chosen supply pressure. The supply pressure is preferably established by introduction of an inert gas (for example nitrogen or argon) or of carbon dioxide, where the pressure (in absolute terms) is 5 mbar to 100 bar, preferably 10 mbar to 50 bar and more preferably 20 mbar to 50 bar.

In one preferred embodiment, the amount of the alkylene oxide used in the activation in step (β) is 0.1% to 25.0% by weight, preferably 1.0% to 20.0% by weight, particularly preferably 2.0% to 16.0% by weight (based on the amount of H-functional starter substance used in step (α)). The alkylene oxide can be added in one step or in two or more portions. Preferably, addition of a portion of the alkylene oxide is followed by interruption of the addition of the alkylene oxide until the occurrence of evolution of heat, and only then is the next portion of alkylene oxide added. Preference is also given to a two-stage activation (step β), wherein
(β1) in a first activation stage a first portion of alkylene oxide is added under inert gas atmosphere and
(β2) in a second activation stage a second portion of alkylene oxide is added under carbon dioxide atmosphere.

Step (γ):

The metered addition of H-functional starter substance, alkylene oxide and optionally a suspension medium having no H-functional groups, and/or of carbon dioxide can be effected simultaneously or sequentially (in portions); for example, it is possible to add the total amount of carbon dioxide, the amount of H-functional starter substance or of the suspension medium having no H-functional groups and/or the amount of alkylene oxide metered in in step (γ) all at once or continuously. The term “continuously” as used here can be defined as a mode of addition of a reactant such that a concentration of the reactant effective for the copolymerization is maintained, meaning that, for example, the metered addition may be carried out at a constant metered addition rate, at a varying metered addition rate or portionwise.

It is possible, during the addition of the alkylene oxide, the suspension medium having no H-functional groups and/or H-functional starter substance, to increase or lower the CO₂ pressure gradually or stepwise or to leave it constant. The total pressure is preferably kept constant during the reaction by metered addition of further carbon dioxide. The metered addition of the alkylene oxide, the suspension medium having no H-functional groups and/or H-functional starter substance is effected simultaneously or sequentially with respect to the metered addition of carbon dioxide. It is possible to effect metered addition of the alkylene oxide at a constant metering rate or to increase or lower the metering rate gradually or stepwise or to add the alkylene oxide portionwise. The alkylene oxide is preferably added to the reaction mixture at a constant metering rate. If two or more alkylene oxides are used for synthesis of the polyethercarbonate polyols, the alkylene oxides may be metered in individually or as a mixture. The metered addition of the alkylene oxide, the suspension medium having no H-functional groups and the H-functional starter substance can be effected simultaneously or sequentially, each via separate feeds (additions) or via one or more feeds, in which case the alkylene oxide, the suspension medium having no H-functional groups and the H-functional starter substance can be metered in individually or as a mixture. It is possible via the manner and/or sequence of metered addition of the H-functional starter substance, the alkylene oxide, the suspension medium having no H-functional groups and/or the carbon dioxide to synthesize random, alternating, block or gradient polyethercarbonate polyols.

It is preferable to use an excess of carbon dioxide based on the calculated amount of carbon dioxide incorporated in the polyethercarbonate polyol, since an excess of carbon dioxide is advantageous because of the inertness of carbon dioxide. The amount of carbon dioxide may be determined via the total pressure under the particular reaction conditions. An advantageous total pressure (in absolute terms) for the copolymerization for preparation of the polyethercarbonate polyols has been found to be in the range from 0.01 to 120 bar, preferably 0.1 to 110 bar, more preferably from 1 to 100 bar. It is possible to feed in the carbon dioxide continuously or discontinuously. This depends on how quickly the alkylene oxide is consumed and whether the product is supposed to contain any CO₂-free polyether blocks. The amount of the carbon dioxide (reported as pressure) can likewise vary in the course of addition of the alkylene oxide. CO₂ can also be added to the reactor in solid form and then be converted to the gaseous, dissolved, liquid and/or supercritical state under the chosen reaction conditions.

For the process of the invention, it has additionally been found that the copolymerization (step (γ)) for preparation of the polyethercarbonate polyols is conducted advantageously at 50° C. to 150° C., preferably at 60° C. to 145° C., more preferably at 70° C. to 140° C. and most preferably at 90° C. to 130° C. If temperatures are set below 50° C., the reaction generally becomes very slow. At temperatures above 150° C., the amount of unwanted by-products rises significantly.

Catalyst may likewise be metered in in step (γ). The metered addition of the alkylene oxide, H-functional starter substance, the suspension medium having no H-functional groups and the catalyst can be effected via separate or combined metering points. In a preferred embodiment, alkylene oxide, H-functional starter substances and any suspension medium having no H-functional groups are metered into the reaction mixture continuously via separate metering points. This addition of H-functional starter substance and the suspension medium having no H-functional groups can be effected as a continuous metered addition into the reactor or in portions.

Steps (α), (β) and (γ) may be performed in the same reactor or may each be performed separately in different reactors. Particularly preferred reactor types are: tubular reactors, stirred tanks, loop reactors.

Polyethercarbonate polyols can be prepared in a stirred tank, in which case the stirred tank, according to the embodiment and mode of operation, is cooled via the reactor jacket, internal cooling surfaces and/or cooling surfaces within a pumped circulation system. Both in the semi-batch application, where the product is withdrawn only once the reaction has ended, and in the continuous application, where the product is withdrawn continuously, particular attention should be paid to the metered addition rate of the alkylene oxide. This should be set such that, in spite of the inhibiting action of the carbon dioxide, the alkylene oxide reacts sufficiently quickly. The concentration of free alkylene oxide in the reaction mixture during the activation step (step β) is preferably >0% to 100% by weight, more preferably >0% to 50% by weight, most preferably >0% to 20% by weight (based in each case on the weight of the reaction mixture). The concentration of free alkylene oxide in the reaction mixture during the reaction (step γ) is preferably >0% to 40% by weight, more preferably >0% to 25% by weight, very preferably >0% to 15% by weight (based in each case on the weight of the reaction mixture).

In a preferred embodiment, the mixture containing activated DMC catalyst that results from steps (α) and (β) is further reacted in the same reactor with alkylene oxide, H-functional starter substance, optionally suspension medium having no H-functional groups, and carbon dioxide. In a further preferred embodiment, the mixture containing activated DMC catalyst that results from steps (α) and (β) is further reacted with alkylene oxide, H-functional starter substance, optionally suspension medium having no H-functional groups, and carbon dioxide in another reaction vessel (for example a stirred tank, tubular reactor or loop reactor).

When conducting the reaction in a tubular reactor, the mixture containing activated DMC catalyst that results from the steps (α) and (β), H-functional starter substance, alkylene oxide, optionally suspension medium having no H-functional groups, and carbon dioxide are continuously pumped through a tube. The molar ratios of the coreactants may be varied according to the desired polymer. In a preferred embodiment carbon dioxide is metered in in its liquid or supercritical form to achieve optimal miscibility of the components. It is advantageous to install mixing elements in the tubular reactor for better mixing of the coreactants, such as are marketed for example by Ehrfeld Mikrotechnik GmbH, or mixer-heat exchanger elements which simultaneously improve mixing and heat removal.

Loop reactors can likewise be used for preparation of polyethercarbonate polyols. These generally include reactors with recycling, for example a jet loop reactor, which can also be operated continuously, or a loop-shaped tubular reactor with suitable apparatuses for pumped circulation of the reaction mixture or a loop of a plurality of serially connected tubular reactors. The use of a loop reactor is advantageous especially because backmixing can be achieved here, such that it is possible to keep the concentration of free alkylene oxide in the reaction mixture within the optimal range, preferably in the range from >0% to 40% by weight, more preferably >0% to 25% by weight, most preferably >0% to 15% by weight (based in each case on the weight of the reaction mixture).

Preferably, the polyethercarbonate polyols are prepared in a continuous process which comprises both a continuous copolymerization and a continuous addition of H-functional starter substance and any suspension medium having no H-functional groups.

The invention thus further provides a process wherein in step (γ) H-functional starter substance, alkylene oxide, optionally suspension medium having no H-functional groups and DMC catalyst are continuously metered into the reactor in the presence of carbon dioxide (“copolymerization”) and wherein the resulting reaction mixture (comprising polyethercarbonate polyol and cyclic carbonate) is continuously removed from the reactor. It is preferable when in step (γ) the DMC catalyst is continuously added in the form of a suspension in H-functional starter substance.

For example, for the continuous process for preparing the polyethercarbonate polyols, a DMC catalyst-containing mixture is prepared, then, in step (γ),
(γ1) in each case a portion of the H-functional starter substance, alkylene oxide and carbon dioxide are metered in to initiate the copolymerization, and
(γ2) during the progress of the copolymerization, the remaining amount of each of DMC catalyst, H-functional starter substance, any suspension medium having no H-functional groups, and alkylene oxide is metered in continuously in the presence of carbon dioxide, with simultaneous continuous removal of resulting reaction mixture from the reactor.

In step (γ), the catalyst is preferably added in the form of a suspension in H-functional starter substance, the amount preferably being chosen such that the content of catalyst in the resulting reaction product is 10 to 10 000 ppm, more preferably 20 to 5000 ppm, and most preferably 50 to 500 ppm.

Preferably, steps (α) and (β) are performed in a first reactor, and the resulting reaction mixture is then transferred into a second reactor for the copolymerization of step (γ). However, it is also possible to perform steps (α), (β) and (γ) in one reactor.

The term “continuously” used here can be defined as the mode of addition of a relevant catalyst or reactant such that an essentially continuously effective concentration of the catalyst or the reactant is maintained. Catalyst feeding may be effected in a truly continuous manner or in relatively tightly spaced increments. Continuous addition of H-functional starter substance and continuous addition of the suspension medium having no H-functional groups can likewise be truly continuous or carried out in increments. There would be no departure from the present process in adding a catalyst or reactants incrementally such that the concentration of the materials added drops essentially to zero for a period of time before the next incremental addition. However, it is preferable that the catalyst concentration is kept essentially at the same concentration during the main portion of the progression of the continuous reaction, and that H-functional starter substance is present during the main portion of the copolymerization process. An incremental addition of catalyst and/or reactant which does not substantially influence the nature of the product is nevertheless “continuous” in that sense in which the term is being used here. It is possible, for example, to provide a recycling loop in which a portion of the reacting mixture is recycled to a prior point in the process, thus smoothing out discontinuities caused by incremental additions.

Step (δ)

Optionally, in a step (δ) the reaction mixture from step (γ) can be transferred into a postreactor in which, by way of a postreaction, the content of free alkylene oxide in the reaction mixture is reduced, preferably to <500 ppm. The postreactor may be a tubular reactor, a loop reactor or a stirred tank for example.

The pressure in this postreactor is preferably at the same pressure as in the reaction apparatus in which reaction step (γ) is performed. The temperature in the downstream reactor is preferably 50° C. to 150° C. and more preferably 80° C. to 140° C. The residence time of the reaction mixture in the postreactor is preferably 1.0 to 20.0 hours. In a preferred embodiment, 5 to 100 ppm of component K are added to the resulting mixture after the residence time has elapsed.

The polyethercarbonate polyols obtained have a functionality, for example, of at least 1, preferably of 1 to 8, more preferably of 1 to 6 and most preferably of 2 to 4. The molecular weight is preferably 400 to 10 000 g/mol and more preferably 500 to 6000 g/mol.

Alkylene Oxide

The process may generally employ alkylene oxides (epoxides) having 2-24 carbon atoms. The alkylene oxides having 2-24 carbon atoms are, for example, one or more compounds selected from the group consisting of ethylene oxide, propylene oxide, 1-butene oxide, 2,3-butene oxide, 2-methyl-11,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, mono- or polyepoxidized fats as mono-, di- and triglycerides, epoxidized fatty acids, C₁-C₂₄ esters of epoxidized fatty acids, epichlorohydrin, glycidol, and derivatives of glycidol, for example methyl glycidyl ether, ethyl glycidyl ether, 2-ethylhexyl glycidyl ether, allyl glycidyl ether, glycidyl methacrylate and epoxy-functional alkoxysilanes, for example 3-glycidyoxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane, 3-glycidyloxypropyltriisopropoxysilane. The alkylene oxide used is preferably ethylene oxide and/or propylene oxide, especially propylene oxide. In the process of the invention, the alkylene oxide used may also be a mixture of alkylene oxides.

H-Functional Starter Substance

Suitable H-functional starter substances (“starters”) used may be compounds having alkoxylation-active H atoms and having a molar mass of 18 to 4500 g/mol, preferably of 62 to 500 g/mol and more preferably of 62 to 182 g/mol.

Alkoxylation-active groups having active H atoms are, for example, —OH, —NH₂ (primary amines), —NH— (secondary amines), —SH, and —CO₂H, preferably —OH and −NH₂, more preferably —OH. H-functional starter substances used are, for example, one or more compounds selected from the group consisting of mono- or polyhydric alcohols, polyfunctional amines, polyfunctional thiols, amino alcohols, thio alcohols, hydroxy esters, polyether polyols, polyester polyols, polyester ether polyols, polyethercarbonate polyols, polycarbonate polyols, polycarbonates, polyethyleneimines, polyetheramines, polytetrahydrofurans (e.g. PolyTHF® from BASF), polytetrahydrofuran amines, polyether thiols, polyacrylate polyols, castor oil, the mono- or diglyceride of ricinoleic acid, monoglycerides of fatty acids, chemically modified mono-, di- and/or triglycerides of fatty acids, and C₁-C₂₄ alkyl fatty acid esters containing an average of at least 2 OH groups per molecule. The C₁-C₂₄ alkyl fatty acid esters containing an average of at least 2 OH groups per molecule are for example commercial products such as Lupranol Balance® (from BASF AG), Merginol® products (from Hobum Oleochemicals GmbH), Sovermol® products (from Cognis Deutschland GmbH & Co. KG) and Soyol®TM products (from USSC Co.).

Monofunctional starter substances used may be alcohols, amines, thiols and carboxylic acids. Monofunctional alcohols used may be: methanol, ethanol, 1-propanol, 2-propanol, 1-butanol, 2-butanol, tert-butanol, 3-buten-1-ol, 3-butyn-1-ol, 2-methyl-3-buten-2-ol, 2-methyl-3-butyn-2-ol, propargyl alcohol, 2-methyl-2-propanol, 1-tert-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, phenol, 2-hydroxybiphenyl, 3-hydroxybiphenyl, 4-hydroxybiphenyl, 2-hydroxypyridine, 3-hydroxypyridine, 4-hydroxypyridine. Suitable monofunctional amines include: butylamine, tert-butylamine, pentylamine, hexylamine, aniline, aziridine, pyrrolidine, piperidine, morpholine. Monofunctional thiols used may be: ethanethiol, 1-propanethiol, 2-propanethiol, 1-butanethiol, 3-methyl-1-butanethiol, 2-butene-1-thiol, thiophenol. Monofunctional carboxylic acids include: formic acid, acetic acid, propionic acid, butyric acid, fatty acids such as stearic acid, palmitic acid, oleic acid, linoleic acid, linolenic acid, benzoic acid, acrylic acid.

Polyhydric alcohols suitable as H-functional starter substances are, for example, dihydric alcohols (for example ethylene glycol, diethylene glycol, propylene glycol, dipropylene glycol, propane-1,3-diol, butane-1,4-diol, butene-1,4-diol, butyne-1,4-diol, neopentyl glycol, pentane-1,5-diol, methylpentanediols (for example 3-methylpentane-1,5-diol), hexane-1,6-diol; octane-1,8-diol, decane-1,10-diol, dodecane-1,12-diol, bis(hydroxymethyl)cyclohexanes (for example 1,4-bis(hydroxymethyl)cyclohexane), triethylene glycol, tetraethylene glycol, polyethylene glycols, dipropylene glycol, tripropylene glycol, polypropylene glycols, dibutylene glycol and polybutylene glycols); trihydric alcohols (for example trimethylolpropane, glycerol, trishydroxyethyl isocyanurate, castor oil); tetrahydric alcohols (for example pentaerythritol); polyalcohols (for example sorbitol, hexitol, sucrose, starch, starch hydrolyzates, cellulose, cellulose hydrolyzates, hydroxy-functionalized fats and oils, in particular castor oil), and all modification products of these aforementioned alcohols with different amounts of ε-caprolactone.

The H-functional starter substance may also be selected from the substance class of the polyether polyols having a molecular weight Mₙ in the range from 18 to 4500 g/mol and a functionality of 2 to 3. Preference is given to polyether polyols constructed from repeating ethylene oxide and propylene oxide units, preferably having a proportion of propylene oxide units of from 35% to 100%, particularly preferably having a proportion of propylene oxide units of from 50% to 100%. These may be random copolymers, gradient copolymers, alternating copolymers or block copolymers of ethylene oxide and propylene oxide.

The H-functional starter substance may also be selected from the substance class of the polyester polyols. At least bifunctional polyesters are used as the polyester polyols. Polyester polyols preferably consist of alternating acid and alcohol units. Acid components used are, for example, succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride or mixtures of the acids and/or anhydrides mentioned. Alcohol components used are, for example, ethanediol, propane-1,2-diol, propane-1,3-diol, butane-1,4-diol, pentane-1,5-diol, neopentyl glycol, hexane-1,6-diol, 1,4-bis(hydroxymethyl)cyclohexane, diethylene glycol, dipropylene glycol, trimethylolpropane, glycerol, pentaerythritol or mixtures of the alcohols mentioned. Employing dihydric or polyhydric polyether polyols as the alcohol component affords polyester ether polyols which can likewise serve as starter substances for preparation of the polyethercarbonate polyols.

In addition, H-functional starter substances used may be polycarbonatediols which are prepared, for example, by reaction of phosgene, dimethyl carbonate, diethyl carbonate or diphenyl carbonate and bifunctional alcohols or polyester polyols or polyether polyols. Examples of polycarbonates may be found, for example, in EP-A 1359177.

In a further embodiment of the invention, polyethercarbonate polyols may be used as H-functional starter substances. More particularly, polyethercarbonate polyols obtainable by the process of the invention described here are used. To this end, these polyethercarbonate polyols used as H-functional starter substance are prepared beforehand in a separate reaction step.

The H-functional starter substance generally has a functionality (i.e. the number of polymerization-active H atoms per molecule) of 1 to 8, preferably of 2 or 3. The H-functional starter substance is used either individually or as a mixture of at least two H-functional starter substances.

It it is particularly preferable when the H-functional starter substance is at least one of compounds selected from the group consisting of ethylene glycol, propylene glycol, propane-1,3-diol, butane-1,3-diol, butane-1,4-diol, pentane-1,5-diol, 2-methylpropane-1,3-diol, neopentyl glycol, hexane-1,6-diol, octane-1,8-diol, diethylene glycol, dipropylene glycol, glycerol, trimethylolpropane, pentaerythritol, sorbitol, polyethercarbonate polyols having a molecular weight Mₙ in the range from 150 to 8000 g/mol with a functionality of 2 to 3, and polyether polyols having a molecular weight Mₙ in the range from 150 to 8000 g/mol with a functionality of 2 to 3.

In a particularly preferred embodiment, in step (α) the portion of H-functional starter substance is selected from at least one compound of the group consisting of polyethercarbonate polyols having a molecular weight Mₙ in the range from 150 to 8000 g/mol with a functionality of 2 to 3, and polyether polyols having a molecular weight Mₙ in the range from 150 to 8000 g/mol and a functionality of 2 to 3. In a further particularly preferred embodiment, the H-functional starter substance in step (γ) is selected from at least one compound of the group consisting of ethylene glycol, propylene glycol, propane-1,3-diol, butane-1,3-diol, butane-1,4-diol, pentane-1,5-diol, 2-methylpropane-1,3-diol, neopentyl glycol, hexane-1,6-diol, octane-1,8-diol, diethylene glycol, dipropylene glycol, glycerol, trimethylolpropane, pentaerythritol and sorbitol.

The polyethercarbonate polyols are prepared by catalytic addition of carbon dioxide and alkylene oxide onto H-functional starter substance. In the context of the invention “H-functional” is understood to mean the number of alkoxylation-active H atoms per molecule of the starter substance.

The H-functional starter substance which is metered continuously into the reactor during the reaction may contain component K.

Component K

Compounds suitable as component K are characterized in that they contain at least one phosphorus-oxygen bond. Examples of suitable components K are phosphoric acid and phosphoric salts, phosphoryl halides, phosphoramides, phosphoric esters and salts of the mono- and diesters of phosphoric acid.

In the context of the invention the esters cited as possible components K hereinabove and hereinbelow are to be understood as meaning in each case the alkyl ester, aryl ester and/or alkaryl ester derivatives.

Examples of suitable phosphoric esters include mono-, di- or triesters of phosphoric acid, mono-, di-, tri- or tetraesters of pyrophosphoric acid and mono-, di-, tri-, tetra- or polyesters of polyphosphoric acid with alcohols having 1 to 30 carbon atoms. Examples of compounds suitable as component K include: triethyl phosphate, diethyl phosphate, monoethyl phosphate, tripropyl phosphate, dipropyl phosphate, monopropyl phosphate, tributyl phosphate, dibutyl phosphate, monobutyl phosphate, trioctyl phosphate, tris(2-ethylhexyl) phosphate, tris(2-butoxyethyl) phosphate, diphenyl phosphate, dicresyl phosphate, fructose 1,6-biphosphate, glucose 1-phosphate, bis(dimethylamido)phosphoric chloride, bis(4-nitrophenyl) phosphate, cyclopropylmethyl diethyl phosphate, dibenzyl phosphate, diethyl 3-butenyl phosphate, dihexadecyl phosphate, diisopropyl chlorophosphate, diphenyl phosphate, diphenyl chlorophosphate, 2-hydroxyethyl methacrylate phosphate, mono(4-chlorophenyl) dichlorophosphate, mono(4-nitrophenyl) dichlorophosphate, monophenyl dichlorophosphate, tridecyl phosphate, tricresyl phosphate, trimethyl phosphate, triphenyl phosphate, phosphoric acid tripyrolidide, phosphorus sulfochloride, dimethylamidophosphoric dichloride, methyl dichlorophosphate, phosphoryl bromide, phosphoryl chloride, phosphoryl quinoline chloride calcium salt and O-phosphorylethanolamine, alkali metal and ammonium dihydrogenphosphates, alkali metal, alkaline earth metal and ammonium hydrogenphosphates, alkali metal, alkaline earth metal and ammonium phosphates.

The term “esters of phosphoric acid” (phosphoric esters) is understood also to include the products obtainable by propoxylation of phosphoric acid (available as Exolit® OP 560 for example).

Other suitable components K are phosphonic acid and phosphorous acid and also mono- and diesters of phosphonic acid and mono-, di- and triesters of phosphorous acid and their respective salts, halides and amides.

Examples of suitable phosphonic esters include mono- or diesters of phosphonic acid, alkylphosphonic acids, arylphosphonic acids, alkoxycarbonylalkylphosphonic acids, alkoxycarbonylphosphonic acids, cyanoalkylphosphonic acids and cyanophosphonic acids or mono-, di-, tri- or tetraesters of alkyldiphosphonic acids with alcohols having 1 to 30 carbon atoms.

Examples of suitable phosphorous esters include mono-, di- or triesters of phosphorous acid with alcohols having 1 to 30 carbon atoms. This includes, for example, phenylphosphonic acid, butylphosphonic acid, dodecylphosphonic acid, ethylhexylphosphonic acid, octylphosphonic acid, ethylphosphonic acid, methylphosphonic acid, octadecylphosphonic acid and their mono- and dimethyl esters, ethyl esters, butyl esters, ethylhexyl esters or phenyl esters, dibutyl butylphosphonate, dioctyl phenylphosphonate, triethyl phosphonoformate, trimethyl phosphonoacetate, triethyl phosphonoacetate, trimethyl 2-phosphonopropionate, triethyl 2-phosphonopropionate, tripropyl 2-phosphonopropionate, tributyl 2-phosphonopropionate, triethyl 3-phosphonopropionate, triethyl 2-phosphonobutyrate, triethyl 4-phosphonocrotonate, (12-phosphonododecyl)phosphonic acid, phosphonoacetic acid, methyl P,P-bis(2,2,2-trifluoroethyl)phosphonoacetate, trimethylsilyl P,P-diethylphosphonoacetate, tert-butyl P,P-dimethylphosphonoacetate, P,P-dimethyl phosphonoacetate potassium salt, P,P-dimethylethyl phosphonoacetate, 16-phosphonohexadecanoic acid, 6-phosphonohexanoic acid, N-(phosphonomethyl)glycine, N-(phosphonomethyl)glycine monoisopropylamine salt, N-(phosphonomethyl)iminodiacetic acid, (8-phosphonooctyl)phosphonic acid, 3-phosphonopropionic acid, 11-phosphonoundecanoic acid, pinacol phosphonate, trilauryl phosphite, tris(3-ethyloxethanyl-3-methyl) phosphite, heptakis(dipropylene glycol) phosphite, 2-cyanoethyl bis(diisopropylamido)phosphite, methyl bis(diisopropylamido)phosphite, dibutyl phosphite, dibenzyl (diethylamido)phosphite, di-tert-butyl (diethylamido)phosphite, diethyl phosphite, diallyl (diisopropylamido)phosphite, dibenzyl (diisopropylamido)phosphite, di-tert-butyl (diisopropylamido)phosphite, dimethyl (diisopropylamido)phosphite, dibenzyl (dimethylamido)phosphite, dimethyl phosphite, trimethylsilyl dimethylphosphite, diphenyl phosphite, methyl dichlorophosphite, mono(2-cyanoethyl) diisopropylamidochlorophosphite, o-phenylene chlorophosphite, tributyl phosphite, triethyl phosphite, triisopropyl phosphite, triphenyl phosphite, tris(tert-butyl-dimethylsilyl) phosphite, tris-1,1,1,3,3,3-hexafluoro-2-propyl phosphite, tris(trimethylsilyl) phosphite, dibenzyl phosphite. The term “esters of phosphorous acid” is also understood to include the products obtainable by propoxylation of phosphorous acid (available as Exolit® OP 550 for example).

Other suitable components K are phosphinic acid, phosphonous acid and phosphinous acid and their respective esters. Examples of suitable phosphinic esters include esters of phosphinic acid, alkylphosphinic acids, dialkylphosphinic acids or arylphosphinic acids with alcohols having 1 to 30 carbon atoms. Examples of suitable phosphonous esters include mono- and diesters of phosphonous acid or arylphosphonous acid with alcohols having 1 to 30 carbon atoms. This includes, for example, diphenylphosphinic acid or 9,10-dihydro-9-oxa-10-phosphaphenanthrene 10-oxide.

The esters of phosphoric acid, phosphonic acid, phosphorous acid, phosphinic acid, phosphonous acid or phosphinous acid suitable as component K are generally obtained by reaction of phosphoric acid, pyrophosphoric acid, polyphosphoric acids, phosphonic acid, alkylphosphonic acids, arylphosphonic acids, alkoxycarbonylalkylphosphonic acids, alkoxycarbonylphosphonic acids, cyanoalkylphosphonic acids, cyanophosphonic acid, alkyldiphosphonic acids, phosphonous acid, phosphorous acids, phosphinic acid, phosphinous acid or the halogen derivatives or phosphorus oxides thereof with hydroxy compounds having 1 to 30 carbon atoms such as methanol, ethanol, propanol, butanol, pentanol, hexanol, heptanol, octanol, nonanol, decanol, dodecanol, tridecanol, tetradecanol, pentadecanol, hexadecanol, heptadecanol, octadecanol, nonadecanol, methoxymethanol, ethoxymethanol, propoxymethanol, butoxymethanol, 2-ethoxyethanol, 2-propoxyethanol, 2-butoxyethanol, phenol, ethyl hydroxyacetate, propyl hydroxyacetate, ethyl hydroxypropionate, propyl hydroxypropionate, ethane-1,2-diol, propane-1,2-diol, 1,2,3-trihydroxypropane, 1,1,1-trimethylolpropane or pentaerythritol.

Phosphine oxides suitable as component K contain one or more alkyl, aryl or aralkyl groups having 1-30 carbon atoms bonded to the phosphorus. Preferred phosphine oxides have the general formula R₃P═O where R is an alkyl, aryl or aralkyl group having 1-20 carbon atoms. Examples of suitable phosphine oxides include trimethylphosphine oxide, tri(n-butyl)phosphine oxide, tri(n-octyl)phosphine oxide, triphenylphosphine oxide, methyldibenzylphosphine oxide and mixtures thereof.

Also suitable as component K are compounds of phosphorus that can form one or more P—O bond(s) by reaction with OH-functional compounds (such as water or alcohols for example). Examples of such compounds of phosphorus that are useful include phosphorus(V) sulfide, phosphorus tribromide, phosphorus trichloride and phosphorus triiodide. It is also possible to employ any desired mixtures of the abovementioned compounds as component K. Phosphoric acid is particularly preferred as component K.

Suspension Medium

The optionally employed suspension medium contains no H-functional groups. Suitable suspension media having no H-functional groups are all polar aprotic, weakly polar aprotic and nonpolar aprotic solvents, none of which contain any H-functional groups. Suspension media having no H-functional groups that are used may also be a mixture of two or more of these suspension media. The following polar aprotic solvents are mentioned here by way of example: 4-methyl-2-oxo-1,3-dioxolane (also referred to hereinafter as cyclic propylene carbonate or cPC), 1,3-dioxolan-2-one (also referred to hereinafter as cyclic ethylene carbonate or cEC), acetone, methyl ethyl ketone, acetonitrile, nitromethane, dimethyl sulfoxide, sulfolane, dimethylformamide, dimethylacetamide and N-methylpyrrolidone. The group of the nonpolar aprotic and weakly polar aprotic solvents includes, for example, ethers, for example dioxane, diethyl ether, methyl tert-butyl ether and tetrahydrofuran, esters, for example ethyl acetate and butyl acetate, hydrocarbons, for example pentane, n-hexane, benzene and alkylated benzene derivatives (e.g. toluene, xylene, ethylbenzene) and chlorinated hydrocarbons, for example chloroform, chlorobenzene, dichlorobenzene and carbon tetrachloride. Preferred suspension media used having no H-functional groups are 4-methyl-2-oxo-1,3-dioxolane, 1,3-dioxolan-2-one, toluene, xylene, ethylbenzene, chlorobenzene and dichlorobenzene, and mixtures of two or more of these suspension media; particular preference is given to 4-methyl-2-oxo-1,3-dioxolane and 1,3-dioxolan-2-one or a mixture of 4-methyl-2-oxo-1,3-dioxolane and 1,3-dioxolan-2-one.

In step (γ) preferably 2% by weight to 20% by weight, more preferably 5% by weight to 15% by weight and especially preferably 7% by weight to 11% by weight of the suspension medium having no H-functional groups is metered in, based on the sum total of the components metered in in step (γ).

DMC Catalysts

DMC catalysts for use in the homopolymerization of alkylene oxides are known in principle from the prior art (see, for example, US-A 3 404 109, US-A 3 829 505, US-A 3 941 849 and US-A 5 158 922). DMC catalysts, which are described, for example, in US-A 5 470 813, EP-A 700 949, EP-A 743 093, EP-A 761 708, WO 97/40086, WO 98/16310 and WO 00/47649, have a very high activity and enable the preparation of polyethercarbonate polyols at very low catalyst concentrations, such that there is generally no longer a need to separate the catalyst from the finished product. A typical example is that of the highly active DMC catalysts which are described in EP-A 700 949 and contain not only a double metal cyanide compound (e.g. zinc hexacyanocobaltate(III)) and an organic complex ligand (e.g. tert-butanol) but also a polyether having a number-average molecular weight greater than 500 g/mol.

The DMC catalysts are preferably obtained by

(A) in the first step reacting an aqueous solution of a metal salt with the aqueous solution of a metal cyanide salt in the presence of one or more organic complex ligands, e.g. of an ether or alcohol,

(B) wherein in the second step the solid is separated from the suspension obtained from (A) by means of known techniques (such as centrifugation or filtration),

(C) wherein in a third step the isolated solid is optionally washed with an aqueous solution of an organic complex ligand (for example by resuspension and subsequent reisolation by filtration or centrifugation),

(D) wherein the solid obtained is subsequently dried, optionally after pulverization, at temperatures of generally 20-120° C. and at pressures of generally 0.1 mbar to standard pressure (1013 mbar), and wherein, in the first step or immediately after the precipitation of the double metal cyanide compound (step (B)), one or more organic complex ligands, preferably in excess (based on the double metal cyanide compound), and optionally further complex-forming components are added. The double metal cyanide compounds present in the DMC catalysts are the reaction products of water-soluble metal salts and water-soluble metal cyanide salts.

For example, an aqueous solution of zinc chloride (preferably in excess based on the metal cyanide salt, for example potassium hexacyanocobaltate) and potassium hexacyanocobaltate are mixed and then dimethoxyethane (glyme) or tert-butanol (preferably in excess based on zinc hexacyanocobaltate) is added to the suspension formed.

Metal salts suitable for preparation of the double metal cyanide compounds preferably have the general formula (II)

M(X)ₙ (II)

wherein

M is selected from the metal cations Zn²⁺, F²⁺, Ni²⁺, Mn²⁺, Co²⁺, Sr²⁺, Sn²⁺, Pb²⁺ and Cu²⁺; M is preferably Zn²⁺, Fe²⁺, Co²⁺or Ni²⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

n is 1 when X=sulfate, carbonate or oxalate and

n is 2 when X=halide, hydroxide, carboxylate, cyanate, thiocyanate, isocyanate, isothiocyanate or nitrate,

or suitable metal salts have the general formula (III)

Mᵣ(X)₃ (III)

wherein

M is selected from the metal cations Fe³⁺, Al³⁺, Co³⁺ and Cr³⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

r is 2 when X=sulfate, carbonate or oxalate and

r is 1 when X=halide, hydroxide, carboxylate, cyanate, thiocyanate, isocyanate, isothiocyanate or nitrate,

or suitable metal salts have the general formula (IV)

M(X)ₛ (IV)

wherein

M is selected from the metal cations Mo⁴⁺, V⁴⁺ and W⁴⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

s is 2 when X=sulfate, carbonate or oxalate and

s is 4 when X=halide, hydroxide, carboxylate, cyanate, thiocyanate, isocyanate, isothiocyanate or nitrate,

or suitable metal salts have the general formula (V)

M(X)ₜ (V)

wherein

M is selected from the metal cations Mo⁶⁺ and W⁶⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

t is 3 when X=sulfate, carbonate or oxalate and

t is 6 when X=halide, hydroxide, carboxylate, cyanate, thiocyanate, isocyanate, isothiocyanate or nitrate.

Examples of suitable metal salts are zinc chloride, zinc bromide, zinc iodide, zinc acetate, zinc acetylacetonate, zinc benzoate, zinc nitrate, iron(II) sulfate, iron(II) bromide, iron(II) chloride, iron(III) chloride, cobalt(II) chloride, cobalt(II) thiocyanate, nickel(II) chloride and nickel(II) nitrate. It is also possible to use mixtures of different metal salts.

Metal cyanide salts suitable for preparation of the double metal cyanide compounds preferably have the general formula (VI)

(Y)ₐM′(CN)_{b}(A)_{c} (VI)

wherein

M′ is selected from one or more metal cations from the group consisting of Fe(II), Fe(III), Co(II), Co(III), Cr(II), Cr(III), Mn(II), Mn(III), Ir(III), Ni(II), Rh(III), Ru(II), V(IV) and V(V); M′ is preferably one or more metal cations from the group consisting of Co(II), Co(III), Fe(II), Fe(III), Cr(III), Ir(III) and Ni(II),

Y is selected from one or more metal cations from the group consisting of alkali metal (i.e. Li⁺, Na⁺, K⁺, Rb⁺) and alkaline earth metal (i.e. Be²⁺, Mg²⁺, Ca²⁺, Sr²⁺, Ba²⁺),

A is selected from one or more anions from the group consisting of halides (i.e. fluoride, chloride, bromide, iodide), hydroxide, sulfate, carbonate, cyanate, thiocyanate, isocyanate, isothiocyanate, carboxylate, azide, oxalate or nitrate, and

a, b and c are integers, the values for a, b and c being selected such as to ensure the electronic neutrality of the metal cyanide salt; a is preferably 1, 2, 3 or 4; b is preferably 4, 5 or 6; c preferably has the value 0.

Examples of suitable metal cyanide salts are sodium hexacyanocobaltate(III), potassium hexacyanocobaltate(III), potassium hexacyanoferrate(II), potassium hexacyanoferrate(III), calcium hexacyanocobaltate(III) and lithium hexacyanocobaltate(III).

Preferred double metal cyanide compounds present in the DMC catalysts are compounds of the general formula (VII)

Mₓ[M′ₓ, (CN)_{y}]_{z} (VII)

where M is as defined in formula (II) to (V) and

M′ is as defined in formula (VI), and

x, x′, y and z are integers and are selected so as to ensure the electronic neutrality of the double metal cyanide compound.

Preferably,

x=3, x′=1, y=6 and z=2,

M=Zn(II), Fe(II), Co(II) or Ni(II) and

M′=Co(III), Fe(III), Cr(III) or Ir(III).

Examples of suitable double metal cyanide compounds are zinc hexacyanocobaltate(III), zinc hexacyanoiridate(III), zinc hexacyanoferrate(III) and cobalt(II) hexacyanocobaltate(III). Further examples of suitable double metal cyanide compounds can be found, for example, in U.S. Pat. No. 5,158,922 (column 8, lines 29-66). Particular preference is given to using zinc hexacyanocobaltate(III).

The organic complex ligands added in the preparation of the DMC catalysts are disclosed, for example, in U.S. Pat. No. 5,158,922 (see especially column 6, lines 9 to 65), US-A 3 404 109, US-A 3 829 505, US-A 3 941 849, EP-A 700 949, EP-A 761 708, JP 4 145 123, US 5 470 813, EP-A 743 093 and WO-A 97/40086). The organic complex ligands used are, for example, water-soluble organic compounds containing heteroatoms such as oxygen, nitrogen, phosphorus or sulfur, which can form complexes with the double metal cyanide compound. Preferred organic complex ligands are alcohols, aldehydes, ketones, ethers, esters, amides, ureas, nitriles, sulfides and mixtures thereof. Particularly preferred organic complex ligands are aliphatic ethers (such as dimethoxyethane), water-soluble aliphatic alcohols (such as ethanol, isopropanol, n-butanol, isobutanol, sec-butanol, tert-butanol, 2-methyl-3-buten-2-ol and 2-methyl-3-butyn-2-ol), compounds containing both aliphatic or cycloaliphatic ether groups and aliphatic hydroxyl groups (for example ethylene glycol mono-tert-butyl ether, diethylene glycol mono-tert-butyl ether, tripropylene glycol monomethyl ether and 3-methyl-3-oxetanemethanol). The most preferred organic complex ligands are selected from one or more compounds from the group consisting of dimethoxyethane, tert-butanol, 2-methyl-3-buten-2-ol, 2-methyl-3-butyn-2-ol, ethylene glycol mono-tert-butyl ether and 3-methyl-3-oxetanemethanol.

Optionally used in the preparation of the DMC catalysts are one or more complex-forming component(s) from the compound classes of the polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylic acid-co-maleic acid), polyacrylonitrile, polyalkylacrylates, polyalkylmethacrylates, polyvinyl methyl ether, polyvinyl ethyl ether, polyvinyl acetate, polyvinyl alcohol, poly-N-vinylpyrrolidone, poly(N-vinylpyrrolidone-co-acrylic acid), polyvinyl methyl ketone, poly (-vinylphenol), poly(acrylic acid-co-styrene), oxazoline polymers, polyalkyleneimines, maleic acid and maleic anhydride copolymers, hydroxyethyl cellulose and polyacetals, or of the glycidyl ethers, glycosides, carboxylic esters of polyhydric alcohols, gallic acid or the salts, esters or amides thereof, cyclodextrins, phosphorus compounds, α,β-unsaturated carboxylic esters or ionic surface- or interface-active compounds.

Preferably, in the preparation of the DMC catalysts, in the first step, the aqueous solutions of the metal salt (e.g. zinc chloride), used in a stoichiometric excess (at least 50 mol %) based on metal cyanide salt (i.e. at least a molar ratio of metal salt to metal cyanide salt of 2.25:1.00), and of the metal cyanide salt (e.g. potassium hexacyanocobaltate) are converted in the presence of the organic complex ligand (e.g. tert-butanol), forming a suspension containing the double metal cyanide compound (e.g. zinc hexacyanocobaltate), water, excess metal salt and the organic complex ligand. The organic complex ligand may be present in the aqueous solution of the metal salt and/or of the metal cyanide salt or it is added directly to the suspension obtained after precipitation of the double metal cyanide compound. It has been found to be advantageous to mix the metal salt and the metal cyanide salt aqueous solutions and the organic complex ligand by stirring vigorously. Optionally, the suspension formed in the first step is subsequently treated with a further complex-forming component. The complex-forming component is preferably used in a mixture with water and organic complex ligand. A preferred process for performing the first step (i.e. the preparation of the suspension) is effected using a mixing nozzle, more preferably using a jet disperser as described in WO-A 01/39883.

In the second step (step (B)) the solid (i.e. the precursor of the catalyst) is isolated from the suspension by known techniques, such as centrifugation or filtration.

In a preferred variant, the isolated solid is subsequently washed in a third process step (step (C)) with an aqueous solution of the organic complex ligand (for example by resuspension and subsequent reisolation by filtration or centrifugation). Water-soluble by-products for example, such as potassium chloride, can be removed from the catalyst in this way. The amount of the organic complex ligand in the aqueous wash solution is preferably between 40% and 80% by weight, based on the overall solution.

Further complex-forming component is optionally added to the aqueous wash solution in the third step, preferably in the range between 0.5% and 5% by weight, based on the overall solution. It is also advantageous to wash the isolated solid more than once. It is preferable when in a first wash step (C-1) this solid is washed with an aqueous solution of the organic complex ligand (for example by resuspension and subsequent reisolation by filtration or centrifugation), in order in this way to remove, for example, water-soluble by-products, such as potassium chloride, from the catalyst. It is particularly preferable when the amount of the organic complex ligand in the aqueous wash solution is between 40% and 80% by weight based on the overall solution for the first wash step. In the further washing steps (C-2) either the first washing step is repeated once or several times, preferably from one to three times, or, preferably, a nonaqueous solution, such as a mixture or solution of organic complex ligand and further complex-forming component (preferably in the range between 0.5% and 5% by weight, based on the total amount of the wash solution of step (C-2)), is used as the wash solution, and the solid is washed with it once or more than once, preferably from one to three times.

The isolated and optionally washed solid is subsequently dried, optionally after pulverization, at temperatures of generally 20-100° C. and at pressures of generally 0.1 mbar to standard pressure (1013 mbar).

A preferred process for isolation of the DMC catalysts from the suspension by filtration, filtercake washing and drying is described in WO-A 01/80994.

As well as the DMC catalysts based on zinc hexacyanocobaltate (Zn₃[Co(CN)₆]₂) that are used with preference, it is also possible to use other metal complex catalysts based on the metals zinc and/or cobalt that are known to those skilled in the art from the prior art for the copolymerization of epoxides and carbon dioxide for the process of the invention. This especially includes what are called zinc glutarate catalysts (described, for example, in M. H. Chisholm et al., Macromolecules 2002, 35, 6494), what are called zinc diiminate catalysts (described, for example, in S. D. Allen, J. Am. Chem. Soc. 2002, 124, 14284), what are called cobalt salen catalysts (described, for example, in U.S. Pat. No. 7,304,172 B2, US 2012/0165549 A1), and bimetallic zinc complexes having macrocyclic ligands (described, for example, in M. R. Kember et al., Angew. Chem., Int. Ed., 2009, 48, 931).

In a first embodiment the invention relates to a process for removing gaseous constituents dissolved in liquid reaction mixtures in the copolymerization of alkylene oxide and carbon dioxide, characterized in that
(η) prior to decompression the liquid reaction mixture has a pressure of 5.0 to 100.0 bar (absolute), wherein the following process stages are performed in the specified sequence:
   (i) decompression of the reaction mixture by at least 50% of the prevailing pressure,
   (ii) subsequent droplet separation with first defoaming and
(iii) subsequent bubble separation with second defoaming to clarify the liquid phase,
wherein the process stages (i) to (iii) are performed one or more times until the resulting reaction mixture has a pressure of 0.01 to <5.00 bar (absolute).

In a second embodiment, the invention relates to a process according to the first embodiment, characterized in that the reaction mixture resulting from (η) has a pressure of 0.01-2.50 bar (absolute).

In a third embodiment, the invention relates to a process according to either of embodiments 1 or 2, characterized in that prior to decompression in process stage (i) the reaction mixture has a temperature in the range of 60-150° C.

In a fourth embodiment, the invention relates to a process according to any of embodiments 1 to 3, characterized in that in process stage (ii) the droplet separation is performed by means of centrifugal forces.

In a fifth embodiment, the invention relates to a process according to any of embodiments 1 to 4, characterized in that a cyclone is employed in process stage (ii).

In a sixth embodiment, the invention relates to a process according to the fifth embodiment, characterized in that the reaction mixture exits the cyclone in process stage (ii) solely by gravitation.

In a seventh embodiment, the invention relates to a process according to any of embodiments 1 to 6, characterized in that a coalescer is used in process stage (iii).

In an eighth embodiment, the invention relates to a process according to the seventh embodiment, characterized in that the coalescer contains at least one fabric element.

In a ninth embodiment, the invention relates to a process according to the eighth embodiment, characterized in that the fabric element is a knitted metal fabric.

In a tenth embodiment, the invention relates to a process according to the eighth or ninth embodiment, characterized in that the fabric element has a density of 600-1200 kg/m³, preferably 800-1200 kg/m³, particularly preferably 800-1050 kg/m³.

In an eleventh embodiment, the invention thus relates to a process for preparing polyethercarbonate polyols by addition of alkylene oxide and carbon dioxide onto H-functional starter substance in the presence of a double metal cyanide (DMC) catalyst or in the presence of a metal complex catalyst based on the metals zinc and/or cobalt, wherein
(γ) alkylene oxide and carbon dioxide are added onto H-functional starter substance in a reactor in the presence of a double metal cyanide catalyst or a metal complex catalyst based on the metals zinc and/or cobalt to obtain a reaction mixture containing the polyethercarbonate polyol,
(δ) the reaction mixture obtained in step (γ) optionally remains in the reactor or is optionally continuously transferred into a postreactor, wherein in each case by way of a postreaction the content of free alkylene oxide in the reaction mixture is reduced, and
(η) subsequently CO₂ and any dissolved residual alkylene oxide are removed in an operation comprising the process stages (i)-(iii) according to any of the embodiments 1 to 10.

In a twelfth embodiment, the invention relates to a process according to the eleventh embodiment, characterized in that prior to step (γ)
(α) a portion of the H-functional starter substance and/or a suspension medium having no H-functional groups is initially charged in a reactor optionally together with DMC catalyst or a metal complex catalyst based on the metals zinc and/or cobalt,
(β) a DMC catalyst is optionally activated by adding a portion (based on the total amount of alkylene oxide used in the activation and copolymerization) of the alkylene oxide to the mixture resulting from step (α), wherein this addition of a portion of alkylene oxide can optionally be carried out in the presence of CO₂ and wherein the temperature spike (“hotspot”) occurring on account of the subsequent exothermic chemical reaction and/or a pressure drop in the reactor is awaited in each case and wherein step (β) for activation may also be carried out two or more times.

In a thirteenth embodiment, the invention relates to a process according to the eleventh or twelfth embodiment, characterized in that in step (δ) in a postreactor the free alkylene oxide concentration is reduced to <500 ppm at the outlet of the postreactor.

In a fourteenth embodiment, the invention relates to a process according to any of embodiments 11 to 13, characterized in that in step (δ) and prior to step (η) the reaction mixture is held at a temperature of 50° C. to 150° C. for a residence time of 1.0 h to 20.0 h and 5 to 100 ppm of a component K are added to the resulting mixture after this residence time has elapsed.

### EXAMPLES

### Example 1

(γ) Addition of propylene oxide and carbon dioxide onto a mixture of glycerol and propylene glycol in the presence of a DMC catalyst in a stirred tank at 107° C. and an initial reaction pressure of 74 bar, wherein propylene oxide, carbon dioxide and the mixture of glycerol and propylene glycol are continuously metered into the reactor.

The obtained crude product is a polyethercarbonate polyol having a molar weight of 2700 g/mol, a functionality of 2.8 and a content of 20% by weight of incorporated CO₂. The crude product further contains 4% by weight of dissolved CO₂ and 7% by weight of cyclic propylene carbonate (cPC). The DMC catalyst used in the preparation of the employed crude product was the DMC catalyst prepared according to example 6 in WO 01/80994 A1.
(η) Process stage (i): Decompression of the reaction mixture from step (γ) from 74 bar to 1 bar (absolute).
   Process stage (ii): The mixture of liquid and gas phase formed in the decompression of the reaction mixture is supplied to a droplet separator. The employed droplet separator is a cyclone having a volume of 0.06 liters and tangential entry of the biphasic flow. The lower part for discharging the foam-containing liquid phase is of conical construction. The cyclone has an outlet in the upper region for discharging the removed gas phase. The cyclone is fitted with mantle heating for temperature adjustment. The cyclone is arranged 2 meters above a coalescer so that the discharge from the cyclone flows through the subsequent coalescer without a pump The temperature of the mixture upon entry into the cyclone is 80° C.
   Process stage (iii): The mixture is subsequently transferred into a coalescer for bubble separation. The coalescer is a horizontal, cylindrical vessel having a diameter D=56 mm and a volume of 0.6 liters. Installed in the front region of the coalescer is a fabric element (spiral-wound module made of wire, D=50 mm, L=50 mm, D/L=1, Rhodius) having a density of 1000 kg/m³. For visual checking of the phase separation and the defoaming the coalescer is provided with a sightglass in the rear region, wherein the flow zone downstream of the fabric element is observable. The coalescer is fitted with half-pipe coils for heating. The mixture enters in an axial direction and flows through the fabric element. The withdrawal of removed gas phase (upward) and of the liquid phase (downward) is carried out in the region downstream of the fabric element. The temperature of the mixture upon entry into the coalescer is 80° C. and is heated to 100° C. in the coalescer.

The process is continuously operated, wherein the mass flow of the crude product upstream of the decompression is 9 kg/h. Over 48 hours of continuous operation no foam phase and only isolated gas bubbles are visible in the defoaming chamber with visible flow zone downstream of the fabric element after the process stage (iii).

### Example 2

(γ) Preparation of the crude product is carried out as in example 1.
(η) Process stage (i): Decompression of the reaction mixture from step (γ) from 74 bar to 1 bar (absolute).
   Process stage (ii): The mixture of liquid and gas phase formed in the decompression of the reaction mixture is supplied to a droplet separator. The employed droplet separator is a cyclone having a volume of 0.06 liters and tangential entry of the biphasic flow. The lower part for discharging the foam-containing liquid phase is of conical construction. The cyclone has an outlet in the upper region for discharging the removed gas phase. The cyclone is fitted with mantle heating for temperature adjustment. The cyclone is arranged 2 meters above a coalescer so that the discharge from the cyclone flows through the coalescer without a pump. The temperature of the mixture upon entry into the cyclone is 80° C.
   Process stage (iii): The mixture is subsequently transferred into a coalescer for bubble separation. The coalescer is a horizontal, cylindrical vessel having a diameter D=56 mm and a volume of 0.6 liters. Installed in the front region of the coalescer is a fabric element (spiral-wound module made of wire, D=30 mm, L=30 mm, D/L=1, Rhodius) having a density of 1000 kg/m³. For visual checking of the phase separation and the defoaming the coalescer is provided with a sightglass in the rear region, wherein the flow zone downstream of the fabric element is observable. The coalescer is fitted with half-pipe coils for heating. The mixture enters in an axial direction and flows through the fabric element. The withdrawal of removed gas phase (upward) and of the liquid phase (downward) is carried out in the region downstream of the fabric element. The temperature of the mixture upon entry into the coalescer is 80° C. and is heated to 100° C. in the coalescer.

The process is continuously operated, wherein the mass flow of the crude product upstream of the decompression is 9 kg/h. Over 48 hours of continuous operation no foam phase and only isolated gas bubbles are visible in the defoaming chamber with visible flow zone downstream of the fabric element after the process stage (iii).

### Example 3

(γ) Preparation of the crude product is carried out as in example 1.
(η) Process stage (i): Decompression of the reaction mixture from step (y) from 74 bar to 1 bar (absolute).
   Process stage (ii): The mixture of liquid and gas phase formed in the decompression of the reaction mixture is supplied to a droplet separator. The employed droplet separator is a cyclone having a volume of 0.06 liters and tangential entry of the biphasic flow. The lower part for discharging the foam-containing liquid phase is of conical construction. The cyclone has an outlet in the upper region for discharging the removed gas phase. The cyclone is fitted with mantle heating for temperature adjustment. The cyclone is arranged 2 meters above a coalescer so that the discharge from the cyclone flows through the coalescer without a pump. The temperature of the mixture upon entry into the cyclone is 80° C.
   Process stage (iii): The mixture is subsequently transferred into a coalescer for bubble separation. The coalescer is a horizontal, cylindrical vessel having a diameter D=56 mm and a volume of 0.6 liters. Installed in the front region of the coalescer is a fabric element (spiral-wound module made of wire, D=30 mm, L=30 mm, D/L=1, Rhodius) having a density of 850 kg/m³. For visual checking of the phase separation and the defoaming the coalescer is provided with a sightglass in the rear region, wherein the flow zone downstream of the fabric element is observable. The coalescer is fitted with half-pipe coils for heating. The mixture enters in an axial direction and flows through the fabric element. The withdrawal of removed gas phase (upward) and of the liquid phase (downward) is carried out in the region downstream of the fabric element. The temperature of the mixture upon entry into the coalescer is 80° C. and is heated to 100° C. in the coalescer via a mantle heater.

The process is continuously operated, wherein the mass flow of the crude product upstream of the decompression is 9 kg/h. Over 48 hours of continuous operation no foam phase and only isolated gas bubbles are visible in the defoaming chamber with visible flow zone downstream of the fabric element after the process stage (iii).

### Example 4

(γ) Preparation of the crude product is carried out as in example 1.
(η) Process stage (i): Decompression of the reaction mixture from step (γ) from 74 bar to 1 bar (absolute).
   Process stage (ii): The mixture of liquid and gas phase formed in the decompression of the reaction mixture is supplied to a droplet separator. The employed droplet separator is a cyclone having a volume of 0.06 liters and tangential entry of the biphasic flow. The lower part for discharging the foam-containing liquid phase is of conical construction. The cyclone has an outlet in the upper region for discharging the removed gas phase. The cyclone is fitted with a mantle heater for temperature adjustment. The cyclone is arranged 2 meters above a coalescer so that the discharge from the cyclone flows through the coalescer without a pump. The temperature of the mixture upon entry into the cyclone is 80° C.
   Process stage (iii): The mixture is subsequently transferred into a coalescer for bubble separation. The coalescer is a horizontal, cylindrical vessel having a diameter D=56 mm and a volume of 0.6 liters. Installed in the front region of the coalescer is a fabric element (single-thread pressing having a wire diameter of 0.14 mm, D=30 mm, L=30 mm, D/L=1, Rhodius) having a density of 1000 kg/m³. For visual checking of the phase separation and the defoaming the coalescer is provided with a sightglass in the rear region, wherein the flow zone downstream of the fabric element is observable. The coalescer is fitted with half-pipe coils for heating. The mixture enters in an axial direction and flows through the fabric element. The withdrawal of removed gas phase (upward) and of the liquid phase (downward) is carried out in the region downstream of the fabric element. The temperature of the mixture upon entry into the coalescer is 80° C. and is heated to 100° C. in the coalescer via a mantle heater. The process is continuously operated, wherein the mass flow of the crude product upstream of the decompression is 9 kg/h. Over 48 hours of continuous operation no foam phase and only isolated gas bubbles are visible in the defoaming chamber with visible flow zone downstream of the fabric element after the process stage (iii).

1. A process for removing gaseous constituents dissolved in liquid reaction mixtures in the copolymerization of alkylene oxide and carbon dioxide, wherein
(η) prior to decompression the liquid reaction mixture has a pressure of 5.0 to 100.0 bar (absolute), wherein the following process stages are performed in the specified sequence:
(i) decompression of the reaction mixture by at least 50% of the prevailing pressure,
(ii) subsequent droplet separation with first defoaming and
(iii) subsequent bubble separation with second defoaming to clarify the liquid phase, wherein the process stages (i) to (iii) are performed one or more times until the resulting reaction mixture has a pressure of 0.01 to <5.00 bar (absolute).

2. The process as claimed in claim 1, wherein the reaction mixture resulting from (η) has a pressure of 0.01-2.50 bar (absolute).

3. The process as claimed in claim 1, wherein prior to decompression in process stage (i) the reaction mixture has a temperature in the range of 60-150° C.

4. The process as claimed in claim 1, wherein in process stage (ii) the droplet separation is performed by means of centrifugal forces.

5. The process as claimed in claim 1, wherein a cyclone is employed in process stage (ii).

6. The process as claimed in claim 5, wherein the reaction mixture exits the cyclone in process stage (ii) solely by gravitation.

7. The process as claimed in claim 1, wherein a coalescer is used in process stage (iii).

8. The process as claimed in claim 7, wherein the coalescer contains at least one fabric element.

9. The process as claimed in claim 8, wherein the fabric element is a knitted metal fabric.

10. The process as claimed in claim 8, wherein the fabric element has a density of 600-1200 kg/m³.

11. A process for preparing polyethercarbonate polyols by addition of alkylene oxide and carbon dioxide onto H-functional starter substance in the presence of a double metal cyanide (DMC) catalyst or a metal complex catalyst based on the metals zinc and/or cobalt, wherein
(γ) alkylene oxide and carbon dioxide are added onto H-functional starter substance in a reactor in the presence of a double metal cyanide catalyst or a metal complex catalyst based on the metals zinc and/or cobalt to obtain a reaction mixture containing the polyethercarbonate polyol,
(δ) the reaction mixture obtained in step (γ) optionally remains in the reactor or is optionally continuously transferred into a postreactor, wherein in each case by way of a postreaction the content of free alkylene oxide in the reaction mixture is reduced, and
(η) subsequently CO₂ and any dissolved residual alkylene oxide are removed in an operation comprising the process stages (i)-(iii) according to claim 1.

12. The process as claimed in claim 11, wherein prior to step (γ)
(α) a portion of the H-functional starter substance and/or a suspension medium having no H-functional groups is initially charged in a reactor optionally together with DMC catalyst or a metal complex catalyst based on the metals zinc and/or cobalt,
(β) a DMC catalyst is optionally activated by adding a portion (based on the total amount of alkylene oxide used in the activation and copolymerization) of the alkylene oxide to the mixture resulting from step (α), wherein this addition of a portion of alkylene oxide can optionally be carried out in the presence of CO₂ and wherein the temperature spike occurring on account of the subsequent exothermic chemical reaction and/or a pressure drop in the reactor is awaited in each case and wherein step (β) for activation may also be carried out two or more times.

13. The process as claimed in claim 11, wherein in step (δ) in a postreactor the free alkylene oxide concentration is reduced to <500 ppm at the outlet of the postreactor.

14. The process as claimed in claim 1, wherein in step (δ) and prior to step (η) the reaction mixture is held at a temperature of 50° C. to 150° C. for a residence time of 1.0 h to 20.0 h and 5 to 100 ppm of a component K are added to the resulting mixture after this residence time has elapsed.

15. The process as claimed in claim 8, wherein the fabric element has a density of 800-1200 kg/m³.

16. The process as claimed in claim 8, wherein the fabric element has a density of 800-1050 kg/m³.
